(19) United States
(12) Patent Application Publication
(10) Pub. No.: US 2009/0299579 A1
(43) Pub. Date: Dec. 3, 2009

(54) Kinematic-based method of estimating the absolute roll angle of a vehicle body

(76) Inventors: Aleksander B. Hac, Dayton, OH (US); David J. Nichols, Carmel, IN (US); Daniel Sygnarowicz, Wojnicz (PL)

Correspondence Address: DELPHI TECHNOLOGIES, INC., M/C 480-410-202, PO BOX 5052, TROY, MI, 48007, US

(21) Appl. No.: 12/154,876

(22) Filed: May 28, 2008

(51) Int. Cl. G05D 1/08; G01P 3/80; G01P 3/44

(52) U.S. Cl. 701/46

(57) ABSTRACT

The absolute roll angle of a vehicle body is estimated by blending two preliminary roll angle estimates based on their frequency so that the blended estimate continuously favors the more accurate of the preliminary roll angle estimates. A first preliminary roll angle estimate based on the measured roll rate is improved by initially compensating the roll rate signal for bias error using roll rate estimates inferred from other measured parameters. And a second preliminary roll angle estimate is determined based on the kinematic relationship among roll angle, lateral acceleration, yaw rate and vehicle speed. The blended estimate of roll angle utilizes a blending coefficient that varies with the frequency of the preliminary roll angle signals, and a blending factor used in the blending coefficient is set to different values depending whether the vehicle is in a steady-state or transient condition.

### TECHNICAL FIELD

The present invention relates to estimation of the absolute roll angle of a vehicle body for side airbag deployment and/or brake control, and more particularly to an improved kinematic-based estimation method.

### BACKGROUND OF THE INVENTION

A number of vehicular control systems including vehicle stability control (VSC) systems and rollover detection/prevention systems utilize various sensed parameters to estimate the absolute roll angle of the vehicle body—that is, the angle of rotation of the vehicle body about its longitudinal axis relative to the level ground plane. In addition, knowledge of absolute roll angle is required to fully compensate measured lateral acceleration for the effects of gravity when the vehicle body is inclined relative to the level ground plane.

In general, the absolute roll angle of a vehicle must be estimated or inferred because it cannot be measured directly in a cost effective manner. Ideally, it would be possible to determine the absolute roll angle by simply integrating the output of a roll rate sensor, and in fact most vehicles equipped with VSC and/or rollover detection/prevention systems have at least one roll rate sensor. However, the output of a typical roll rate sensor includes some DC bias or offset that would be integrated along with the portion of the output actually due to roll rate. For this reason, many systems attempt to remove the sensor bias prior to integration. As disclosed in the U.S. Pat. No. 6,542,792 to Schubert et al., for example, the roll rate sensor output can be dead-banded and high-pass filtered prior to integration. While these techniques can be useful under highly transient conditions where the actual roll rate signal is relatively high, they can result in severe under-estimation of roll angle in slow or nearly steady-state maneuvers where it is not possible to separate the bias from the portion of the sensor output actually due to roll rate.

A more effective approach, disclosed in the U.S. Pat. Nos. 6,292,759 and 6,678,631 to Schiffmann, is to form an additional estimate of roll angle that is particularly reliable in slow or nearly steady-state maneuvers, and blend the two roll angle estimates based on specified operating conditions of the vehicle to form the roll angle estimate that is supplied to the VSC and/or rollover detection/prevention systems. In the Shiffmann patents, the additional estimate of roll angle is based on vehicle acceleration measurements, and a coefficient used to blend the two roll angle estimates has a nominal value except under rough-road or airborne driving conditions during which the coefficient is changed to favor the estimate based on the measured roll rate.

Of course, any of the above-mentioned approaches are only as good as the individual roll angle estimates. For example, the additional roll angle estimate used in the above-mentioned Schiffmann patents tends to be inaccurate during turning maneuvers. Accordingly, what is needed is a way of forming a more accurate estimate of absolute roll angle.

### SUMMARY OF THE INVENTION

The present invention provides an improved method of estimating the absolute roll angle of a vehicle body under any operating condition, including normal driving, emergency maneuvers, driving on banked roads and near rollover situations. The roll angle estimate is based on typically sensed parameters, including roll rate, lateral acceleration, yaw rate, vehicle speed, and optionally, longitudinal acceleration. Roll rate sensor bias is identified by comparing the sensed roll rate with roll rate estimates inferred from other measured parameters for fast and accurate removal of the bias. A first preliminary estimate of roll angle, generally reliable in nearly steady-state conditions, is determined from a kinematic relationship involving lateral acceleration, yaw rate and vehicle speed. The final or blended estimate of roll angle is then determined by blending the preliminary estimate with a second preliminary estimate based on the bias-corrected measure of roll rate. In the blending process, the relative weighting between two preliminary roll angle estimates depends on their frequency and on the driving conditions so that the final estimate continuously favors the more accurate of the preliminary estimates. The blended estimate is used for several purposes, including estimating the lateral velocity and side-slip angle of the vehicle.

### BRIEF DESCRIPTION OF THE DRAWINGS

FIG. 1 is a diagram of a vehicle during a cornering maneuver on a banked road;

FIG. 2 is a diagram of a system for the vehicle of FIG. 1, including a microprocessor-based controller for carrying out the method of this invention; and

FIG. 3 is a flow diagram representative of a software routine periodically executed by the microprocessor-based controller of FIG. 2 for carrying out the method of this invention.

### DESCRIPTION OF THE PREFERRED EMBODIMENT

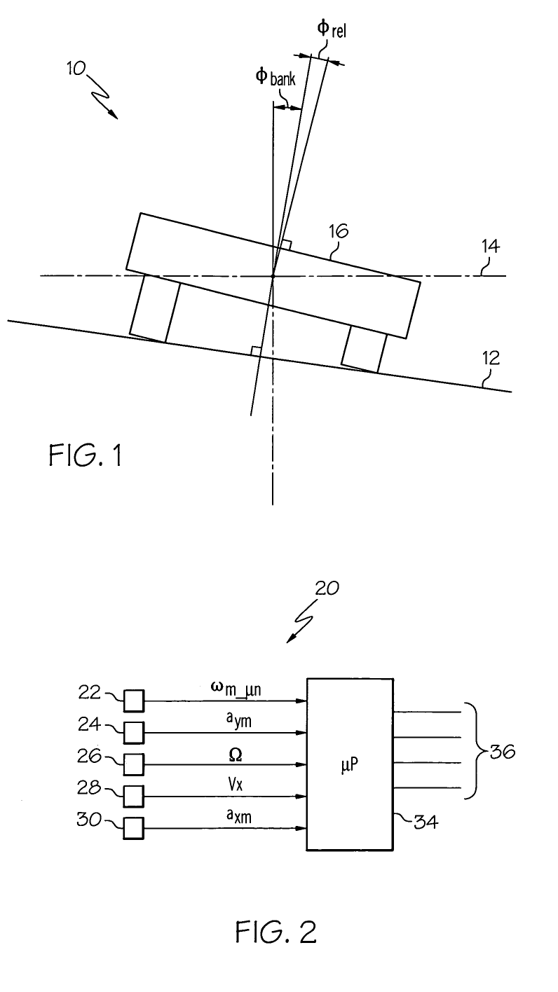

Referring to FIG. 1, the reference numeral 10 generally designates a vehicle being operated on a road surface 12. In the illustration, the road surface 12 is laterally inclined (i.e., banked) relative to the level ground plane 14 by an angle φ_{bank}. Additionally, the body 16 of vehicle 10 has a roll angle φᵣₑₗ relative to the road surface 12 due to suspension and tire compliance. The total or absolute roll angle φ of the vehicle body 16 thus includes both the bank angle φ_{bank} and the relative roll angle φᵣₑₗ.

If the roll rate w of vehicle 10 about its longitudinal axis is measured, an estimate φₑ_{_{ω}} of the total roll angle φ can be determined in principle by integrating the measured roll rate, as follows:

$${φ}_{e ω} ( t ) = {\int }_{0}^{t} {ω}_{m} ( τ ) d τ \qquad ( 1 )$$

where t denotes time and ωₘ is the measured roll rate. Unfortunately, the output of a typical roll rate sensor includes some bias error that would be integrated along with the portion of the output actually due to roll rate. Thus, pure integration of the measured roll rate has infinite sensitivity to the bias error because the error is integrated over time. When dead-banding and high-pass (i.e., wash-out) filtering are used to compensate for the bias error, there is still a conflict between the immunity to bias and the ability to track slowly-varying (or constant) roll angles because the bias compensation also reduces the portion of the signal actually due to roll rate. As a result, a roll angle estimate based on roll rate integration is reasonably good during quick transient maneuvers, but less accurate during slow maneuvers or in nearly steady-state conditions when the roll angle changes slowly. As explained below, one aspect of the present invention is directed to an improved method of compensating for the bias error in a measured roll rate signal without substantially diminishing the portion of the signal actually due to roll rate.

An alternative way of determining the total roll angle θ is to consider it in the context of the kinematic relationship:

a_{ym}=\dot{v}_{y}+vₓΩ−g sin φ (2)

where v_{y} is the lateral velocity of vehicle center-of-gravity, vₓ is the vehicle longitudinal velocity, Ω is vehicle yaw rate, and g is the acceleration of gravity (9.806 m/s²). The sign convention used in equation (2) assumes that lateral acceleration a_{ym} and yaw rate Ω are positive in a right turn, but the roll angle φ due to the turning maneuver is negative.

During nearly steady-state conditions, the derivative of lateral velocity (i.e., \dot{v}_{y}) is relatively small, and an estimate φₑₖ of the roll angle φ can be obtained by ignoring \dot{v}_{y} and solving equation (2) for 0 as follows:

$${φ}_{ek} = {sin}^{- 1} \frac{{v}_{x} Ω - {a}_{ym}}{g} \qquad ( 3 )$$

The longitudinal velocity vₓ, the yaw rate Ω, and the lateral acceleration a_{ym} can be measured, and g is simply a gravitational constant as mentioned above. Thus, a reasonably good estimate φₑₖ of roll angle φ under nearly steady-state conditions may be easily calculated. However, the accuracy of the estimate φₑₖ deteriorates in transient maneuvers where the derivative of lateral velocity is non-negligible.

In summary, the foregoing methods of estimating absolute roll angle each have significant limitations that limit their usefulness. As explained above, a roll angle estimate based on roll rate integration is reasonably good during quick transient maneuvers, but less accurate during slow maneuvers or in nearly steady-state conditions when roll angle changes slowly due to inability to separate the bias error from the portion of the signal actually due to roll rate. On the other hand, the roll angle estimate φₑₖ based on the kinematic relationship of equations (2) and (3) is reasonably good during nearly steady-state (low frequency) maneuvers, but unreliable during transient (high frequency) maneuvers.

It can be seen from the above that the two roll angle estimation methods are complementary in that conditions that produce an unreliable estimate from one estimation method produce an accurate estimate from the other estimation method, and vice versa. Accordingly, the method of this invention blends both estimates in such a manner that the blended roll angle estimate is always closer to the initial estimate that is more accurate.

FIG. 2 is a diagram of an electronic control system 20 installed in vehicle 10 for enhancing vehicle stability and occupant safety. For example, the system 20 may include a vehicle stability control (VSC) system for dynamically activating the vehicle brakes to enhance stability and reduce the likelihood of rollover, and a supplemental restraint system (SRS) for deploying occupant protection devices such as seat belt pretensioners and side curtain air bags in response to detection of an impending rollover event. System sensors include a roll rate sensor 22 responsive to the time rate of angular roll about the vehicle longitudinal axis, a lateral acceleration sensor 24 responsive to the vehicle acceleration along its lateral axis, a yaw rate sensor 26 responsive to the time rate of yaw motion about the vehicle vertical axis, and at least one wheel speed sensor 28 for estimating the vehicle velocity along its longitudinal axis. Optionally, the system 20 additionally includes a longitudinal acceleration sensor 30 responsive to the vehicle acceleration along its longitudinal axis. In practice, ordinary VSC systems include most if not all of the above sensors. Output signals produced by the sensors 22-30 are supplied to a microprocessor-based controller 34 which samples and processes the measured signals, carries out various control algorithms, and produces outputs 36 for achieving condition-appropriate control responses such as brake activation and deployment of occupant restraints. Of course, the depicted arrangement is only illustrative; for example, the functionality of controller 34 may be performed by two or more individual controllers if desired.

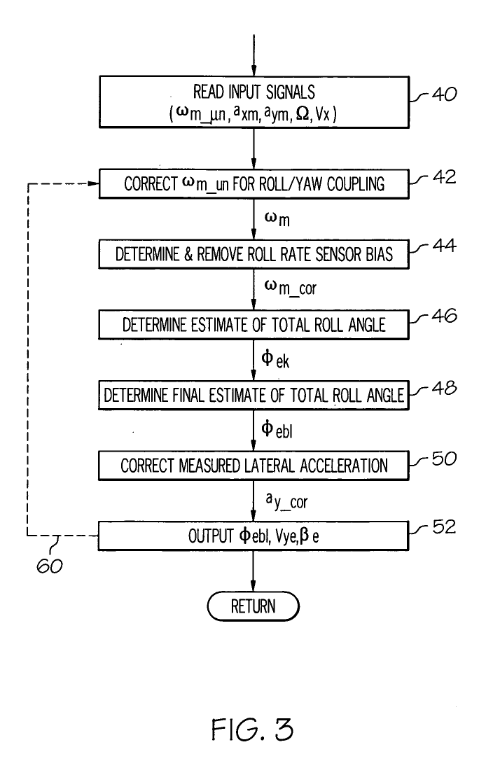

FIG. 3 depicts a flow diagram representative of a software routine periodically executed by the microprocessor-based controller 34 of FIG. 2 for carrying out the method of the present invention. The input signals read at block 40 of the flow diagram include measured uncompensated roll rate ωₘ_{_{—}}ᵤₙ, measured lateral acceleration a_{ym}, yaw rate Ω, vehicle speed vₓ, and optionally, hand-wheel (steering) angle HWA and measured longitudinal acceleration aₓₘ. It is assumed for purposes of the present disclosure that the yaw rate Ω and lateral acceleration a_{ym} input signals have already been compensated for bias error, as is customarily done in VSC systems. Furthermore, it is assumed that all the input signals have been low-pass filtered to reduce the effect of measurement noise.

Block 42 pertains to systems that include a sensor 30 for measuring longitudinal acceleration aₓₘ, and functions to compensate the measured roll rate ωₘ_{_{—}}ᵤₙ for pitching of vehicle 10 about the lateral axis. Pitching motion affects the roll rate detected by sensor 22 due to cross coupling between the yaw rate and roll rate vectors when the vehicle longitudinal axis is inclined with respect to the horizontal plane 14. This occurs, for example, during driving on a spiral ramp. Under such conditions the vertical yaw rate vector has a component along the longitudinal (i.e. roll) axis, to which sensor 22 responds. This component is not due to change in roll angle and should be rejected before the roll rate signal is further processed. In general, the false component is equal to the product of the yaw rate Ω and the tangent of the pitch angle θ. The absolute pitch angle θ is estimated using the following kinematic relationship:

aₓₘ=\dot{v}ₓ−v_{y}Ω+g sin θ (4)

where aₓₘ is the measured longitudinal acceleration, \dot{v}ₓ is the time rate of change in longitudinal speed vₓ, v_{y} is the vehicle's side-slip or lateral velocity, Ω is the measured yaw rate, and g is the acceleration of gravity. Equation (4) can be rearranged to solve for pitch angle θ as follows:

$$θ = {sin}^{- 1} \frac{{a}_{xm} - {\dot{v}}_{x} + {v}_{y} Ω}{g} \qquad ( 5 )$$

The term \dot{v}ₓ is obtained by differentiating (i.e., high-pass filtering) the estimated vehicle speed vₓ. If the lateral velocity v_{y} is not available, the product (v_{y}Ω) can be ignored because it tends to be relatively small as a practical matter. However, it is also possible to use a roll angle estimate to estimate the lateral velocity v_{y}, and to feed that estimate back to the pitch angle calculation, as indicated by the dashed flow line 60. Also, the accuracy of the pitch angle calculation can be improved by magnitude limiting the numerator of the inverse-sine function to a predefined threshold such as 4 m/s². The magnitude-limited numerator is then low-pass filtered with, for example, a second-order filter of the form b_{nf}²/(s²+2ζb_{nf}+b_{nf}²), where b_{nf} is the undamped natural frequency of the filter and ζ is the damping ratio (example values are b_{nf}=3 rad/sec and ζ=0.7). Also, modifications in the pitch angle calculation may be made during special conditions such as heavy braking when the vehicle speed estimate vₓ may be inaccurate. In any event, the result of the calculation is an estimated pitch angle θₑ, which may be subjected to a narrow dead-zone to effectively ignore small pitch angle estimates. Of course, various other pitch angle estimation enhancements may be used, and additional sensors such as a pitch rate sensor can be used to estimate θ.

Once the pitch angle estimate θₑ is determined, the measured roll rate is corrected by adding the product of the yaw rate Ω and the tangent of the pitch angle θₑ to the measured roll rate ∫ₘ_{_{—}}ᵤₙ to form the pitch-compensated roll rate ωₘ as follows:

ωₘ=ωₘ_{_{—}}ᵤₙ+Ω tan θₑ (6)

Since in nearly all cases, the pitch angle θₑ is less than 20° or so, equations (5) and (6) can be simplified by assuming that sin θ≅tan θ≅θ. And as mentioned above, the measured roll rate ωₘ_{_{—}}ᵤₙ can be used as the pitch-compensated roll rate ωₘ if the system 20 does not include the longitudinal acceleration sensor 30.

Block 44 is then executed to convert the measured roll rate signal dim into a bias-compensated roll rate signal ωₘ_{_{—}}_{cor} suitable for integrating. In general, this is achieved by comparing ωₘ with two or more roll rate estimates obtained from other sensors during nearly steady-state driving to determine the bias, and then gradually removing the determined bias from ωₘ.

A first roll rate estimate ω_{eay} is obtained by using the relationship:

φ_{eay}=−R_{gain}a_{ym} (7)

to calculate a roll angle Ota corresponding to the measured lateral acceleration a_{ym}, and differentiating the result. The term R_{gain} in equation (7) is the roll gain of vehicle 10, which can be estimated for a given vehicle as a function of the total roll stiffness of the suspension and tires, the vehicle mass, and distance from the road surface 12 to the vehicle's center-of-gravity. However, the measured lateral acceleration a_{ym} is first low-pass filtered to reduce the effect of measurement noise. Preferably, the filter is a second-order filter of the form b_{nf}²/(s²+2ζb_{nf}+b_{nf}²), where b_{nf} is the un-damped natural frequency of the filter and ζ is the damping ratio (example values are b_{nf}=20 rad/s and ζ=0.7). And differentiation of the calculated roll angle φ_{eay} is achieved by passing φ_{eay} through a first-order high-pass filter of the form b_{f}s/(s+b_{f}), where b_{f} is the filter cut off frequency (an example value is b_{f}=20 rad/sec).

A second roll rate estimate ωₑₖ is obtained by using equation (3) to calculate a roll angle φₑₖ and differentiating the result. The derivative of lateral velocity, \dot{v}_{y}, is neglected since near steady-state driving conditions are assumed. Algebraically, φₑₖ is given as:

$${φ}_{ek} = {sin}^{- 1} \frac{{( {v}_{x} Ω - {a}_{ym} )}_{filt}}{g} \qquad ( 8 )$$

As indicated in the above equation, the numerator (vₓΩ−a_{ym}) of the inverse sine function is also low-pass filtered, preferably with the same form of filter used for the a_{ym} in the preceding paragraph. As a practical matter, the inverse sine function can be omitted since the calculation is only performed for small roll angles (less than 3° or so). Differentiation of the calculated roll angle φₑₖ to produce a corresponding roll rate ωₑₖ is achieved in the same way as described for roll angle φ_{eay} in the preceding paragraph.

Once the roll rate estimates ω_{eay} and ωₑₖ have been calculated, a number of tests are performed to determine their stability and reliability. First, the absolute value of each estimate must be below a threshold value for at least a predefined time on the order of 0.3-0.5 sec. Second, the absolute value of their difference (that is, |ω_{eay}−ωₑₖ|) must be below another smaller threshold value for at least a predefined time such as 0.3-0.5 sec. And finally, the absolute value of the difference between the measured lateral acceleration and the product of yaw rate and vehicle speed (that is, |a_{ym}−vₓΩ|) must be below a threshold value such as 1 m/sec² for at least a predefined time such as 0.3-0.5 sec. Instead of requiring the conditions to be met for a predefined time period, it is sufficient to require that the rate-limited versions of these signals satisfy specified conditions.

When the above conditions are all satisfied, the roll rate estimates ω_{eay} and ωₑₖ are deemed to be sufficiently stable and reliable, and sufficiently close to each other, to be used for isolating the roll rate sensor bias error. In such a case, inconsistencies between the estimated roll rates and the measured roll rate are considered to be attributable to roll rate sensor bias error. First, the difference Δωₘ_{_{—}}_{ay} between the measured roll rate ωₘ and the estimated roll rate ω_{eay} is computed and limited in magnitude to a predefined value such as 0.14 rad/sec to form a limited difference Δωₘ_{_{—}}_{ay}_{_{—}}ₗᵢₘ. Then the roll rate sensor bias error ω_{bias} is calculated (and subsequently updated) using the following low-pass filter function:

ω_{bias}(tᵢ₊₁)=(1−bΔt)ω_{bias}(tᵢ)+bΔtΔωₘ_{_{—}}_{ay}_{_{—}}ₗᵢₘ(tᵢ) (9)

where tᵢ₊₁ denotes the current value, tᵢ denotes a previous value, b is the filter cut off frequency (0.3 rad/sec, for example), and Δt is the sampling period. The initial value of ω_{bias} (that is, ω_{bias} (t₀)) is either zero or the value of ω_{bias} from a previous driving cycle. The roll rate bias error ω_{bias} is periodically updated so long as the stability and reliability conditions are met, but updating is suspended when one or more of the specified conditions is not satisfied. As a practical matter, updating can be suspended by setting b=0 in equation (9) so that ω_{bias}(tᵢ₊₁)=ω_{bias}(tᵢ). Finally, the calculated bias error ω_{bias} is subtracted from the measured roll rate ωₘ, yielding the corrected roll rate ωₘ_{_{—}}_{cor}. And if desired, a narrow dead-band may be applied to ωₘ_{_{—}}_{cor} to minimize any remaining uncompensated bias. Alternately, the kinematic-based roll rate estimate ωₑₖ can be used instead of the acceleration-based estimate ω_{eay} to calculate bias error ω_{bias.}

The block 46 is then executed to determine the roll angle estimate from a kinematic relationship using measured lateral acceleration, yaw rate and estimated vehicle speed. Fundamentally, the estimate of roll angle is obtained from equation (3), but with additional processing of the numerator term (vₓΩ−a_{ym}) of the inverse sine function. The value of the numerator term is determined and then limited in magnitude to a threshold value aₜₕᵣₑₛₕ such as 5 m/sec²; the limiting serves to reduce error due to the neglected derivative of lateral velocity when it is large, as may occur during very quick transient maneuvers. The limited difference (vₓΩ−a_{ym})ₗᵢₘ is then passed through a low pass filter to attenuate the effect of noise; for example, the filter may be a second order filter of the form b_{nf}²/(s²+2ζb_{nf}+b_{nf}²) where b_{nf} is the undamped natural frequency of the filter and ζ is the damping ratio (example values are b_{nf}=3 rad/sed and ζ=0.7). The filter output (vₓΩ−a_{ym})ₗᵢₘ_{_{—}}_{filt} is then used as the numerator of equation (3) to calculate the roll angle estimate ωₑₖ as follows:

$${φ}_{ek} = {sin}^{- 1} \frac{{( {v}_{x} Ω - {a}_{ym} )}_{lim\_filt}}{g} \qquad ( 10 )$$

Block 48 is then executed to determine a blended estimate φ_{ebl} of the total roll angle φ by blending φₑₖ with a roll angle determined by integrating the bias-compensated roll rate measurement ωₘ_{_{—}}_{cor}. To avoid explicitly integrating ωₘ_{_{—}}_{cor}, the terms ωₘ_{_{—}}_{cor}, φₑₖ and \dot{φ}_{ebl} can be combined with a blending factor b_{bl}_{_{—}}_{f} in a differential equation as follows:

\dot{φ}_{ebl}+b_{bl}_{_{—}}_{f}φ_{ebl}=b_{bl}_{_{—}}_{f}φₑₜₒₜ+ωₘ_{_{—}}_{cor} (11)

Representing equation (11) in the Laplace domain, and solving for the blended roll angle estimate φ_{ebl} yields:

$${φ}_{e b l} = \frac{{b}_{bl\_f}}{s + {b}_{bl\_f}} {φ}_{ek} + \frac{1}{s + {b}_{bl\_f}} {ω}_{m\_cor} \qquad ( 12 )$$

which in practice is calculated on a discrete-time domain basis as follows:

φ_{ebl}(tᵢ₊₁)=(1−b_{bl}_{_{—}}_{f}Δt)[φ_{ebl}(tᵢ)+Δtωₘ_{_{—}}_{cor}(tᵢ₊₁)]+b_{bl}_{_{—}}_{f}Δtφₑₖ(tᵢ₊₁) (13)

where tᵢ₊₁ denotes the current value, tᵢ denotes a previous value, and Δt is the sampling period. If the roll angle obtained by integrating ωₘ_{_{—}}_{cor} is denoted by φ_{w}, the blended roll angle estimate φ_{ebl} may be equivalently expressed as:

$${φ}_{e b l} = \frac{{b}_{bl\_f}}{s + {b}_{bl\_f}} {φ}_{ek} + \frac{s}{s + {b}_{bl\_f}} {φ}_{ω} \qquad ( 14 )$$

In this form, it is evident that the blended roll angle estimate φ_{ebl} is a weighted sum of φₑₖ and φ_{w}, with the weight dependent on the frequency of the signals (designated by the Laplace operand “s”) so that the blended estimate φ_{ebl} is always closer to the preliminary estimate that is most reliable at the moment. During steady-state conditions, the body roll rate is near-zero and the signal frequencies are also near-zero. Under such steady-state conditions, the coefficient of φₑₖ approaches one and the coefficient of φ_{w} approaches zero, with the result that φₑₖ principally contributes to φ_{ebl}. During transient conditions, on the other hand, the body roll rate is significant, and the signal frequencies are high. Under such transient conditions, the coefficient of φₑₖ approaches zero and the coefficient of φ_{w} approaches one, with the result that φ_{w} principally contributes to φ_{ebl}. The change between these two extreme situations is gradual and the transition depends on the value of blending factor b_{bl}_{_{—}}_{f} (i.e., the filter cut off frequency).

The blending factor b_{bl}_{_{—}}_{f} may be a fixed value, but is preferably adjusted in value depending on whether the vehicle 10 is in a nearly steady-state condition or a transient condition in terms of either the roll motion or the yaw motion of the vehicle. If vehicle 10 is in a nearly steady-state condition, the blending factor b_{bl}_{_{—}}_{f} is set to a relatively high value such as 0.488 rad/sec. to emphasize the contribution of the roll angle estimate φₑₖ to φ_{ebl} while de-emphasizing the estimate φ_{w} based on measured roll rate. If vehicle 10 is in a transient condition, the blending factor b_{bl}_{_{—}}_{f} is set to a relatively low value such as 0.048 rad/sec. to emphasize the contribution of the roll angle estimate φ_{w} to φ_{ebl}, while de-emphasizing the contribution of the kinematic-based roll angle estimate φₑₖ.

According to a preferred embodiment, the presence of a nearly steady-state condition is detected when a set of three predefined conditions have been met for a specified period of time such as 0.5 seconds. First, the magnitude of the bias-compensated roll rate (i.e., |ωₘ_{_{—}}_{cor}|) must be below a first threshold such as 0.25 rad/sec. The second and third conditions pertain to the numerator (vₓΩ−a_{ym}) of equation (3), which is generally proportional to the relative roll angle φᵣₑₗ. The difference (vₓΩ−a_{ym}) is passed through a first-order low pass filter to form (vₓΩ−a_{ym})_{fil}, and then differentiated to form (vₓΩ−a_{ym})_{fil}_{_{—}}_{der}, an indicator of roll rate. The second condition for detecting a nearly steady-state condition is that |(vₓΩ−a_{ym})_{fil}| must be below a threshold such as 4.0 m/sec², and the third condition is that |(vₓΩ−a_{ym})_{fil}_{_{—}}_{der}|must be below a threshold such as 2.0 m/sec³. If all three conditions are satisfied for the specified time period, a nearly steady-state condition is detected and b_{bl}_{_{—}}_{f} is set to the relatively high value of 0.488 rad/sec. Otherwise, a nearly steady-state condition is not detected and b_{bl}_{_{—}}_{f} is set to the relatively low value of 0.048 rad/sec. Of course, those skilled in art will recognize that various other conditions can be established to determine whether the vehicle 10 is in a nearly steady-state condition or a transient condition, using measured or calculated parameters such as change of yaw rate, handwheel (steering) angle HWA, and so on.

Block 50 is then executed to compensate the measured lateral acceleration ay, for the gravity component due to roll angle. The corrected lateral acceleration a_{ycor} is given by the sum (a_{ym}+g sin φ_{ebl}), where φ_{ebl} is the blended roll angle estimate determined at block 48. The corrected lateral acceleration a_{ycor} can be used in conjunction with other parameters such as roll rate and vehicle speed for detecting the onset of a rollover event.

Finally, block 52 is executed to use the blended roll angle estimate φ_{ebl} to estimate other useful parameters including the vehicle side slip (i.e., lateral) velocity v_{y} and side-slip angle β. The derivative of lateral velocity can alternately be expressed as (a_{y}−vₓΩ) or (a_{ym}+g sin φ−vₓΩ), where a_{y} in the expression (a_{y}−vₓΩ) is the actual lateral acceleration, estimated in block 50 as corrected lateral acceleration a_{ycor}. Thus, derivative of lateral velocity may be calculated using a_{ycor} for a_{y} in the expression (a_{y}−vₓΩ), or using the blended roll angle estimate φ_{ebl} for φ in the expression (a_{ym}+g sin φ−vₓΩ). Integrating either expression then yields a reasonably accurate estimate v_{ye} of side slip velocity v_{y}, which can be supplied to block 42 for use in the pitch angle calculation, as indicated by the broken flow line 60. And once the side-slip velocity estimate V_{ye} has been determined, the side-slip angle β at the vehicle's center of gravity is calculated as:

$$β = {tan}^{- 1} \frac{{v}_{ye}}{{v}_{x}} \qquad ( 15 )$$

In summary, the present invention provides a novel and useful way of accurately estimating the absolute roll angle of a vehicle body under any vehicle operating condition by blending two preliminary estimates of roll angle according to their frequency. A first preliminary roll angle estimate based on the measured roll rate is improved by initially compensating the roll rate signal for bias error using roll rate estimates inferred from other measured parameters. And a second preliminary roll angle estimate is determined based on the kinematic relationship among roll angle, lateral acceleration, yaw rate and vehicle speed. The blended estimate of roll angle utilizes a blending coefficient that varies with the frequency of the preliminary roll angle signals so that the blended estimate continuously favors the more accurate of the preliminary roll angle estimates, and a blending factor used in the blending coefficient is set to different values depending whether the vehicle is in a steady-state or transient condition. The blended estimate is used to estimate the actual lateral acceleration, the lateral velocity and side-slip angle of the vehicle, all of which are useful in applications such as rollover detection and vehicle stability control.

While the present invention has been described with respect to the illustrated embodiment, it is recognized that numerous modifications and variations in addition to those mentioned herein will occur to those skilled in the art. For example, the some or all of equations be characterized as look-up tables to minimize computation requirements, and trigonometric functions may be approximated by their Fourier expansion series. Also, the lateral velocity may be determined using a model-based (i.e., observer) technique with the corrected lateral acceleration a_{ycor} as an input, instead of integrating the estimated derivative of lateral velocity. Finally, it is also possible to apply the blending method of this invention to estimation of absolute pitch angle θ in systems including a pitch rate sensor; in that case, a first preliminary pitch angle estimate would be obtained by integrating a bias-compensated measure of the pitch rate, and a second preliminary pitch angle estimate would be obtained from equation (5). Of course, other modifications and variations are also possible. Accordingly, it is intended that the invention not be limited to the disclosed embodiment, but that it have the full scope permitted by the language of the following claims.

1. A method of operation for a vehicle having a body that rolls about a longitudinal axis relative to a level ground plane, comprising the steps of:
determining a first preliminary estimate of a total roll angle of the vehicle body based on a signal produced by a roll rate sensor, said first preliminary estimate having an accuracy that is highest under transient conditions when a roll rate of the vehicle body is relatively high;
determining a second preliminary estimate of the total roll angle based on a measured yaw rate of the vehicle body, an estimated longitudinal velocity of the vehicle body and a measured lateral acceleration of the vehicle body, said second preliminary estimate having an accuracy that is highest under near steady-state conditions when the roll rate of the vehicle body is relatively low;
blending the first and second preliminary estimates of the total roll angle with blending coefficients to form a blended estimate of the total roll angle, where the blending coefficients are continuously variable according to a frequency of said first and second preliminary estimates so that the blended estimate favors the first preliminary estimate under the transient conditions and the second preliminary estimate under the near steady-state conditions; and
controlling a vehicle system based on the blended estimate of the total roll angle.

2. The method of claim 1, including the steps of:
determining a bias error in the signal produced by the roll rate sensor; and
removing the determined bias error from the signal produced by the roll rate sensor before determining said first preliminary estimate of the total roll angle.

3. The method of claim 2, where the step of determining the bias error in the signal produced by the roll rate sensor includes the steps of:
determining at least one auxiliary roll rate estimate based on sensed parameters other than the roll rate during the steady-state conditions;
determining a difference between the auxiliary roll rate estimate and the signal produced by the roll rate sensor;
limiting a magnitude of said difference to form a limited difference; and
determining said bias error by low-pass filtering said limited difference.

4. The method of claim 3, where the step of determining at least one auxiliary roll rate estimate includes the steps of:
determining a roll angle estimate based on sensed parameters other than the roll rate during the steady-state conditions; and
differentiating the determined roll angle estimate to form the auxiliary roll rate estimate.

5. The method of claim 1, including the step of:
determining the second preliminary estimate φₑₖ of the total roll angle according to:
$${φ}_{ek} = {sin}^{- 1} \frac{( {v}_{x} Ω - {a}_{ym} )}{g}$$
where Ω is the measured yaw rate of the vehicle body, vₓ is the estimated longitudinal velocity of the vehicle body, a_{ym} is the measured lateral acceleration of the vehicle body, and g is a gravitational constant.

6. The method of claim 5, including the step of:
magnitude limiting and low-pass filtering the difference (vₓΩ−a_{ym}) before determining the second preliminary estimate φₑₖ of the total roll angle.

7. The method of claim 1, including the steps of:
measuring a lateral acceleration of the vehicle body; and
compensating the measured lateral acceleration for a gravity component due to the blended estimate of the total roll angle; and
controlling the vehicle system based on compensated lateral acceleration.

8. The method of claim 1, including the steps of:
determining a lateral velocity of the vehicle body based on the blended estimate of the total roll angle; and
controlling the vehicle system based on determined lateral velocity.

9. The method of claim 8, including the steps of:
determining a pitch angle of the vehicle body based on the determined lateral velocity, measures of longitudinal acceleration and yaw rate of the vehicle body, and an estimated longitudinal velocity of the vehicle;
compensating the signal produced by the roll rate sensor due to the determined pitch angle; and
determining said first preliminary estimate of the total roll angle based on the compensated roll rate sensor signal.

10. The method of claim 8, including the step of:
determining a side-slip angle of the vehicle based on the determined lateral velocity and an estimate of a longitudinal velocity of the vehicle; and
controlling the vehicle system based on determined side-slip angle.
